(19) United States
(12) Patent Application Publication
(10) Pub. No.: US 2026/0042455 A1
(43) Pub. Date: Feb. 12, 2026

(54) DRIVING ASSISTANCE DEVICE, DRIVING ASSISTANCE METHOD, AND RECORDING MEDIUM

(71) Applicant: NEC Corporation, Minato-ku, Tokyo (JP)

(72) Inventor: Tatsuya OSADA, Tokyo (JP)

(73) Assignee: NEC Corporation, Minato-ku, Tokyo (JP)

(21) Appl. No.: 18/874,148

(22) PCT Filed: Sep. 12, 2022
(86) PCT No.: PCT/JP2022/033991

§ 371 Date: Dec. 12, 2024

(51) Int. Cl. B60W 50/14; B60W 40/09; G06V 20/56; G06V 20/58

(52) U.S. Cl. CPC B60W 50/14; B60W 40/09; G06V 20/58; G06V 20/588; B60W 2050/143; B60W 2050/146; B60W 2300/36; B60W 2420/403; B60W 2552/45; B60W 2554/4029; B60W 2554/80; B60W 2556/50

(57) ABSTRACT

A driving assistance device according to an aspect of the present disclosure includes: at least one memory configured to storing instructions; and at least one processor configured to execute the instructions to: acquire travel information about a vehicle; detect dangerous driving of the vehicle based on sidewalk information that pertains to a sidewalk and that is included in the travel information; and present the dangerous driving in a case where the dangerous driving has been detected.

### TECHNICAL FIELD

The present disclosure relates to a driving assistance device, a driving assistance method, and a recording medium.

### BACKGROUND ART

PTL 1 discloses a video processing device that records only an accident video and a near accident video from a video captured by an in-vehicle camera, recognizes abnormal driving of a vehicle, and detects near accident characteristics of driving. The abnormal driving showing near accident characteristics which is relevant to the illegal driving of the own vehicle is detected by comparing a traveling situation obtained by object recognition of a road or a landscape included in the video, a traveling situation detected by a vehicle state detection unit, and information of road regulations obtained based on the object recognition of the road recognition or the map information.

### CITATION LIST

### Patent Literature

PTL 1: WO 2017/134897 A1

### SUMMARY OF INVENTION

### Technical Problem

The following analysis is given by the inventor. In recent years, in addition to a form in which a business operator such as a restaurant receives an order for a meal and a salesclerk of the restaurant delivers the food, use of a food delivery service has increased with an increase in a business type in which a delivery person of a delivery professional delivers the food instead of the restaurant. As the number of delivery persons increases, traffic violations, self-harm accidents, personal accidents involving pedestrians, and the like of vehicles driven by delivery persons increase due to factors such as the proficiency level of the operation skill of the vehicle driver and the unavailability of the delivery area, and there is a need to feed back a driving situation that tends to cause traffic accidents to the driver and to give a warning when dangerous traveling is detected. As a countermeasure for improving driving skills, it is conceivable to instruct a delivery person with a high driving skill level as an instructor to a driver with little driving experience, but it is difficult due to limitations of labor and time. Therefore, if dangerous driving travel can be performed for the driver, in a case where the driver is traveling close to dangerous driving during traveling, it is possible to warn the driver, to learn driving in advance for a vehicle driver who has little vehicle driving experience, to learn a driving method for a road that the driver passes for the first time in advance for a driver with a long vehicle driving history, and the like, and a decrease in traffic accidents is expected.

In this regard, the video processing device of PTL 1 only detects near accident characteristics such as an approach between surrounding vehicles or an approach of an object other than a vehicle (passenger, animal, road) based on the object recognition result of the video by the in-vehicle camera, and records the near accident video by combining detection information by an acceleration sensor or the like. For this reason, a dangerous travel in which a vehicle is involved in a sidewalk and its periphery where damage tends to be large among traffic accidents is not considered.

An object of the present disclosure is to provide a driving assistance device, a driving assistance method, and a recording medium capable of recording dangerous traveling involving a vehicle on a sidewalk and its periphery, providing information on the dangerous traveling to a driver of the vehicle before and after driving the vehicle, and notifying dangerous driving to a driver who is driving the vehicle.

### Solution to Problem

According to a first point of view, a driving assistance device is provided which includes:

a travel information acquisition means for acquiring travel information about a vehicle;

a detection means for detecting dangerous driving of the vehicle based on sidewalk information that pertains to a sidewalk and that is included in the travel information; and

a driving presentation means for presenting the dangerous driving in a case where the dangerous driving has been detected by the detection means.

According to a second point of view, a driving assistance method is provided which includes:

acquiring travel information of a vehicle;

detecting dangerous driving of the vehicle based on sidewalk information that pertains to a sidewalk included in the travel information; and

presenting the dangerous driving in a case where the dangerous driving has been detected.

According to a third point of view, a recording medium is provided which has stored therein a program causing a computer to execute:

acquiring travel information of a vehicle from the vehicle;

detecting dangerous driving of the vehicle based on sidewalk information that pertains to a sidewalk included in the travel information; and

presenting the dangerous driving to a predetermined output destination in a case where the dangerous driving has been detected. This program is input to a computer device via an input device or a communication interface from the outside, is stored in a storage device, and drives a processor according to a predetermined step or process. This program can display the processing result including the intermediate state for each stage via the display device as necessary, or can communicate with the outside via the communication interface. The computer device therefor typically includes, for example, a processor, a storage device, an input device, a communication interface, and a display device as necessary, which can be connected to each other by a bus. This program can be recorded in a computer-readable (non-transitory) storage medium.

### ADVANTAGEOUS EFFECTS OF INVENTION

According to the present disclosure, it is possible to detect dangerous travel based on a sidewalk and to provide dangerous driving to a driver and a manager. Therefore, it is possible to learn a driving method before actually traveling a vehicle, to avoid dangerous driving during traveling of the vehicle, and to provide feedback regarding dangerous driving after driving, and to prevent occurrence of a traffic accident.

### BRIEF DESCRIPTION OF DRAWINGS

FIG. 1 is a diagram illustrating a configuration of one example embodiment of the present disclosure.

FIG. 2 is a flowchart illustrating an operation of an example embodiment of the present disclosure.

FIG. 3 is a diagram illustrating a configuration of a first example embodiment of the present disclosure.

FIG. 4 is a diagram for explaining a detection method of dangerous driving according to the first example embodiment of the present disclosure, and is a diagram illustrating a first traveling situation of a vehicle in plan view.

FIG. 5 is a diagram schematically illustrating an image acquired by a camera in the first traveling situation illustrated in FIG. 4.

FIG. 6 is a sequence diagram illustrating an operation of the first example embodiment of the present disclosure.

FIG. 7 is a diagram for explaining the detection method of dangerous driving according to the first example embodiment of the present disclosure, and is a diagram illustrating a second traveling situation of the vehicle in plan view.

FIG. 8 is a diagram schematically illustrating an image acquired by the camera in the second traveling situation illustrated in FIG. 7.

FIG. 9 is a diagram for explaining the detection method of dangerous driving according to the first example embodiment of the present disclosure, and is a diagram illustrating a third traveling situation of the vehicle in plan view.

FIG. 10 is a diagram schematically illustrating an image acquired by the camera in the third traveling situation illustrated in FIG. 9.

FIG. 11 is a diagram illustrating a configuration of a second example embodiment of the present disclosure.

FIG. 12 is a diagram for explaining a detection method of dangerous driving according to the second example embodiment of the present disclosure, and is a diagram illustrating a first traveling situation of a vehicle in plan view.

FIG. 13 is a sequence diagram illustrating an operation of the second example embodiment of the present disclosure.

FIG. 14 is a diagram illustrating a configuration of a computer constituting a driving assistance device of the present disclosure.

### EXAMPLE EMBODIMENTS

First, an outline of an example embodiment of the present disclosure will be described with reference to the drawings. The reference numerals in the drawings attached to this outline are attached to each element for convenience as an example for assisting understanding, and are not intended to limit the present disclosure to the illustrated aspects. Connection lines between blocks in the drawings and the like referred to in the following description include both bidirectional and unidirectional. The unidirectional arrow schematically indicates a flow of a main signal (data), and does not exclude bidirectionality. A program is executed via a computer device, and the computer device includes, for example, a processor, a storage device, an input device, a communication interface, and a display device as necessary. The computer device is able to communicate with a device (including a computer) inside or outside the device via a communication interface regardless of wired or wireless. Although there are ports and interfaces at connection points of input and output of each block in the drawing, they are not illustrated.

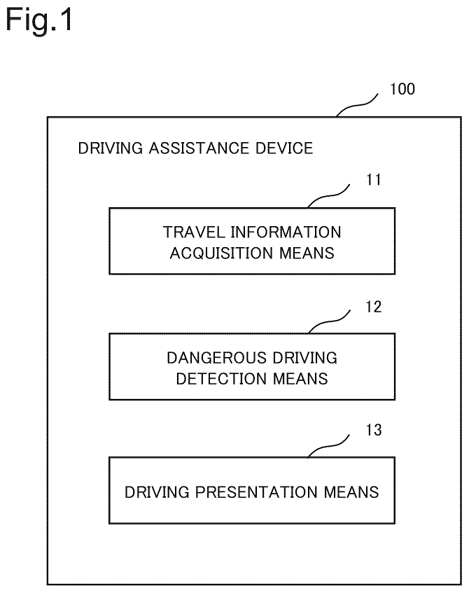

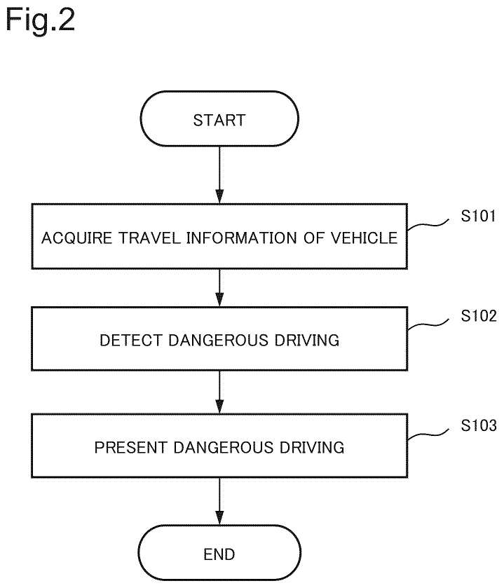

As illustrated in FIG. 1, an example embodiment of the present disclosure is a driving assistance device 100 including a travel information acquisition means 11, a dangerous driving detection means 12, and a driving presentation means 13. A driving assistance method used in the driving assistance device 100 is illustrated in FIG. 2. According to the driving assistance device 100, the travel information acquisition means 11 acquires travel information which is the position information of the vehicle and the driving video (step S101 in FIG. 2). The travel information includes a driving video captured by an imaging means, a vehicle, a pedestrian, and sidewalk information that pertains to coordinate information indicating a position of a sidewalk, a roadway, or the like, which is map information.

Next, the dangerous driving detection means 12 detects whether traveling of the vehicle is relevant to dangerous driving that may lead to a traffic accident based on the acquired sidewalk information (step S102 in FIG. 2). In a case where the dangerous driving detection means 12 detects that the traveling of the vehicle is dangerous driving, the dangerous driving is presented to the driver who drives the vehicle and the manager who manages the vehicle by the driving presentation means 13 (step S103 in FIG. 2).

More specifically, in addition to a drive recorder and a telematics terminal mounted on the vehicle driven by the driver, a camera capable of acquiring various images used for driving assistance is used, and travel information such as video information and a travel locus is transmitted from the vehicle to the travel information acquisition means 11. As a method by which the travel information acquisition means 11 acquires the travel information from the vehicle, a method via a mobile communication network such as a fifth generation mobile communication system or Long Term Evolution (LTE), a method via a roadside unit, or the like can be considered.

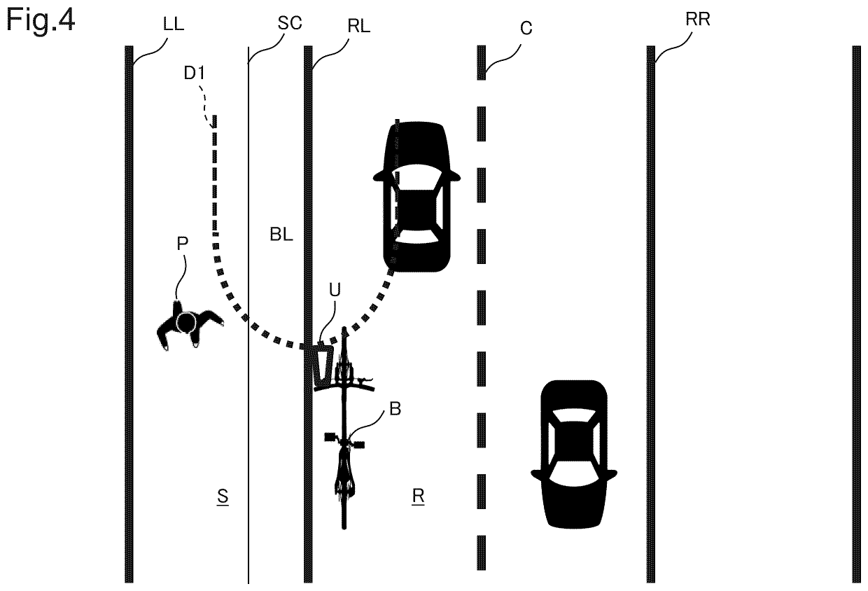

The travel information includes a driving video, position information, and the like, and an image of a roadway, a road surface, surrounding scenery thereof, and the like captured by a camera mounted on the vehicle can be used as the driving video. The current position of the vehicle can be acquired by using radio waves from a GPS satellite or the current position can be calculated based on a moving distance and a traveling direction by a speed sensor and a gyro sensor. Furthermore, the position information of the vehicle can also be acquired based on a map information DB stored in advance and a traveling video captured by the camera. The map information DB includes coordinate information indicating a position of a sidewalk, a road surface of a roadway, a white line indicating the center of a road surface, an edge (shoulder) RL or RR defining the left and right of the road surface, a white line, a yellow line, a traveling vehicle, a bicycle dedicated lane, and the like, and further includes a center line C displayed on the roadway, and various types of information constituting a place where the vehicle is traveling (see FIG. 4).

The dangerous driving detection means 12 determines whether the vehicle is traveling dangerously based on the travel information collected by the travel information acquisition means 11. Specifically, while the vehicle is traveling, the traveling position of the vehicle is identified based on a surrounding image including at least one of the front and the rear of the vehicle, or the position information of the vehicle is compared with map information stored in advance. Therefore, in a case where traveling that violates the laws of the Road Traffic Act or the like is relevant to dangerous driving, the traveling is detected as dangerous driving. For example, in a case where a motorcycle travels on a sidewalk, dangerous driving is detected. For example, in a case where a bicycle travels on a sidewalk that is not permitted to pass by a bicycle, it is detected as dangerous driving. As a method of detecting dangerous travel, it is also possible to select and execute only one of the traveling video and the position information, or it is also possible to use both the information.

Dangerous driving also includes traveling that is arbitrarily defined as dangerous driving by a manager who manages the driving assistance device in addition to traveling that violates a traveling direction, a road sign fixed to a road surface, a traffic signal, and the like. For example, a predetermined distance is set from the boundary between the sidewalk and the roadway (the edge of the roadway in a case where there is no sidewalk) toward the center line of the roadway, and the travelling vehicle or the manager can appropriately set such that the travelling vehicle or the manager regards dangerous travelling in a case where the travelling vehicle travels at a position farther than the predetermined distance. In a case where there is a distinction between a sidewalk and a roadway, when the vehicle travels on the sidewalk or when the distance between the vehicle and a person walking on the sidewalk is less than a predetermined distance, it may be set that the vehicle is regarded as dangerous driving. Whether there is a distinction between a sidewalk where the vehicle is traveling and a roadway may be determined from the width of the sidewalk or sidewalk information set in advance as a sidewalk with a distinction between a sidewalk and a roadway.

The driving presentation means 13 presents dangerous driving to a display device or the like at a predetermined output destination. Specifically, when the vehicle is traveling, it is possible to transmit information pertaining to dangerous driving to a warning means attached to the vehicle and notify the driver of the dangerous traveling by voice, display, or the like. It is possible to prevent dangerous travel by storing a video of dangerous driving, a date and time when dangerous driving has occurred, weather, and the like, and allowing the driver to view the video in order to avoid dangerous driving or allowing another driver to view a route where dangerous driving has occurred in advance.

As described above, according to the present example embodiment, when the travel information of the vehicle operated by the driver is acquired and the dangerous driving is detected based on the sidewalk information included in the travel information, the dangerous driving can be presented, so that the dangerous driving can be presented to the driver or the manager of the vehicle. In particular, a driver who has little travel experience of the vehicle or a driver who has no travel experience of a route where dangerous driving has occurred can learn travel in advance by accessing dangerous driving. In a case where dangerous driving is performed during traveling, warning of dangerous driving can be issued. In this way, since dangerous driving can be presented to the driver before and after traveling during traveling and the manager who manages the driver during traveling, it is possible to prevent occurrence of a traffic accident while suppressing labor of travel education for the driver.

### First Example Embodiment

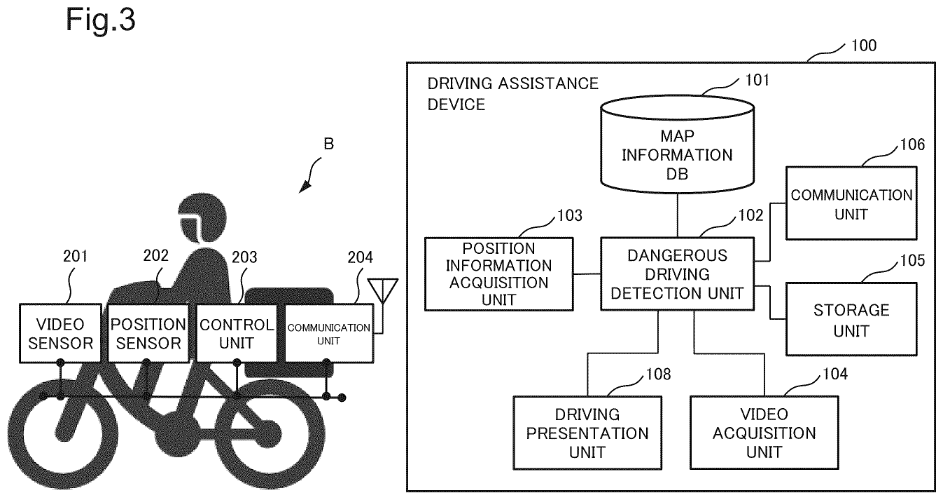

A first example embodiment of the present disclosure in a case where a two-wheeled vehicle is used as a vehicle will be described in detail with reference to the drawings. FIG. 3 is a diagram illustrating a configuration of the first example embodiment of the present disclosure. Referring to FIG. 3, a two-wheeled vehicle B which is a vehicle and a driving assistance device 100 for detecting the presence or absence of dangerous traveling are illustrated. The two-wheeled vehicle B includes a video sensor 201, a position sensor 202, a control unit 203, and a communication unit 204. A camera that captures the traveling direction of the two-wheeled vehicle B is used as the video sensor 201, but can be appropriately changed to an omnidirectional camera or the like. As the position sensor 202, a GPS, a speed sensor, a gyro sensor, or the like mounted on a car navigation system is used. The control unit 203 receives a command from the driving assistance device 100 via the communication unit 204, activates the video sensor 201 and the position sensor 202, and transmits acquired travel information to the driving assistance device 100.

The driving assistance device 100 includes a map information database (map information DB) 101, a dangerous driving detection unit 102, a position information acquisition unit 103, a video acquisition unit 104, a communication unit 106, a storage unit 105, and a driving presentation unit 108.

The video acquisition unit 104 receives the traveling video, which is the travel information transmitted via the communication unit 204 of the two-wheeled vehicle B, by the video acquisition unit 104 via the communication unit 106. The traveling video is converted into video data for detecting dangerous driving by the video acquisition unit 104. Using the video data obtained by the video acquisition unit 104, the dangerous driving detection unit 102 detects whether it is relevant to dangerous driving.

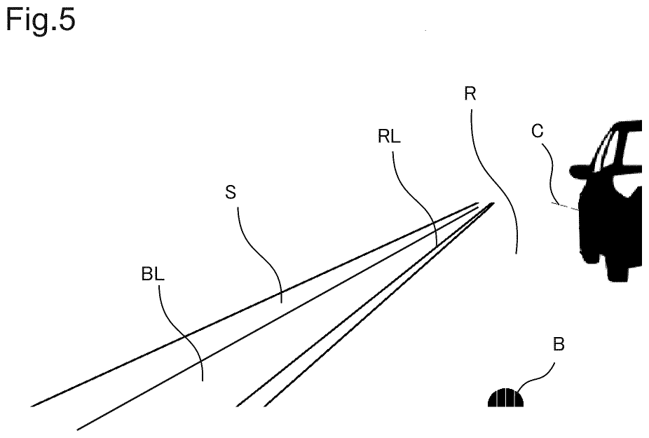

For example, the traveling video of a video area DI illustrated in FIG. 4 is acquired as illustrated in FIG. 5. The video data includes information indicating that the two-wheeled vehicle B travels near an edge RL indicating the boundary between a sidewalk S and a roadway R. In a case where the two-wheeled vehicle B exceeds a predetermined distance with respect to the direction of the center line C from the edge RL, the dangerous driving detection unit 102 detects that the traveling of the two-wheeled vehicle B is dangerous driving. On the other hand, in a case where it is detected that the two-wheeled vehicle B is traveling within the predetermined distance, it is detected that the traveling of the two-wheeled vehicle B is not dangerous driving.

A traffic sign captured by the camera, for example, a roadside strip which is a left side portion of a roadway and is used as a sidewalk and is adjacent to the roadway, a bicycle dedicated lane provided on the sidewalk, a traffic signal, and the like are also stored in the map information DB 101 of the driving assistance device 100, and it is also possible to detect whether it is relevant to dangerous driving by using an element that can be recognized from a driving video captured by the camera. For example, in a case where a vehicle is traveling in a lane exclusive for automobiles, it is possible to configure such that the vehicle is traveling on a sidewalk but is not detected as dangerous driving. Further, dangerous driving can also be detected from coordinate information that is position information of the vehicle. For example, instead of the driving video, it is also possible to detect whether dangerous driving is possible by collating coordinate information that is position information of the vehicle with coordinate information of a road, a sidewalk, a roadway, a bicycle dedicated lane, and the like stored in the map information DB 101.

The predetermined distance from the edge RL, which is the boundary between the sidewalk S and the roadway R, can be acquired by a method of acquiring the predetermined distance from the video data, a method of comparing the current position of the two-wheeled vehicle B obtained from the position sensor 202 described later with data of coordinate information of the sidewalk S and the roadway R stored in the map information DB 101 that stores map information, or the like. That is, in the present example embodiment, the vehicle acquiring the travel information from the position information acquisition unit 103 and the video acquisition unit 104 is used, but the driving assistance device 100 can also be applied to a vehicle including either the position information acquisition unit 103 or the video acquisition unit 104.

In the present example embodiment, it is detected that dangerous driving has been performed for a single two-wheeled vehicle B, but it is also possible to detect dangerous driving for a plurality of two-wheeled vehicles B. For example, dangerous driving data detected in relation to one two-wheeled vehicle can also be used for detecting dangerous driving of another two-wheeled vehicle.

As the position information acquisition unit 103, a global positioning system (GPS), a speed sensor, and a gyro sensor can be used. The dangerous driving detection unit 102 includes a computer or an electronic control unit (ECU) that functions as a detection unit that detects dangerous driving of the two-wheeled vehicle B that is a vehicle. The driving presentation unit 108 is typically a display device such as a display or a mobile terminal capable of displaying information on detected dangerous driving, but is a distribution device for providing the dangerous driving information to a terminal or the like possessed by a person who browses the dangerous driving information without providing a display unit in the driving assistance device 100 itself.

The vehicle in which dangerous driving is detected is not limited to a bicycle, and includes a taxi, a bus, a railway vehicle, an airplane, a motorcycle, a kick board, and the like.

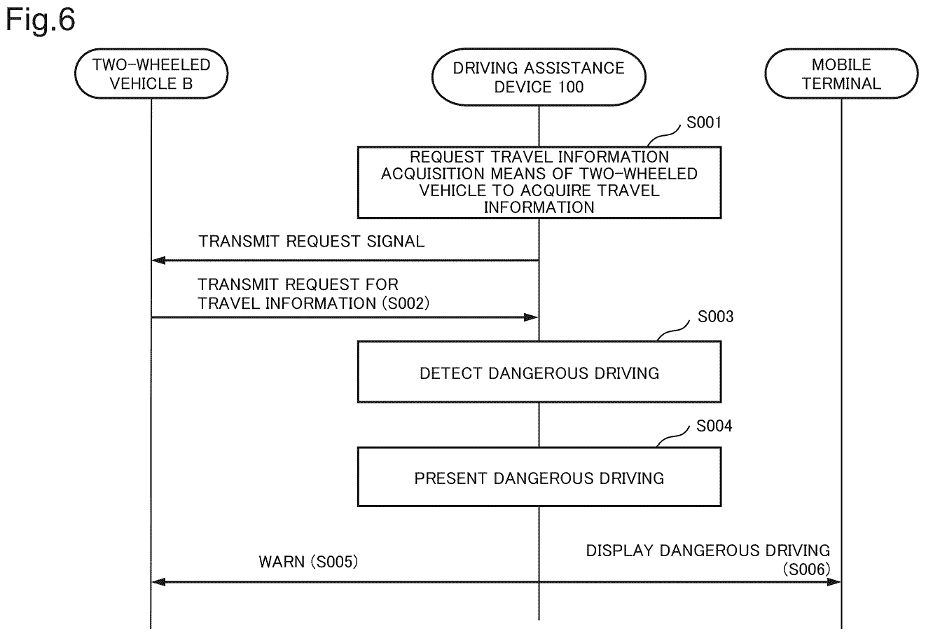

An operation of the present example embodiment will be described with reference to the drawings. FIG. 6 is a sequence diagram illustrating the operation of the first example embodiment of the present disclosure. Referring to FIG. 6, first, a signal requesting acquisition of travel information is transmitted from the driving assistance device 100 to the video sensor 201 and the position sensor 202, which are the travel information acquisition means of the two-wheeled vehicle (step S001). The two-wheeled vehicle that has received the request signal transmits travel information to the driving assistance device 100 (step S002).

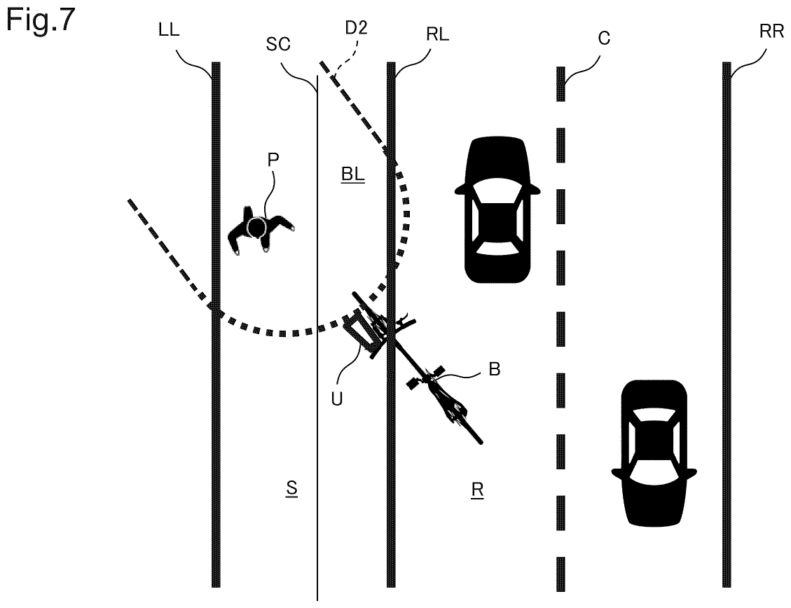

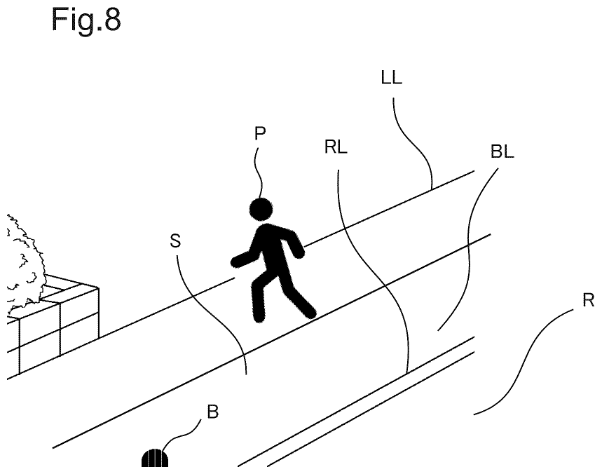

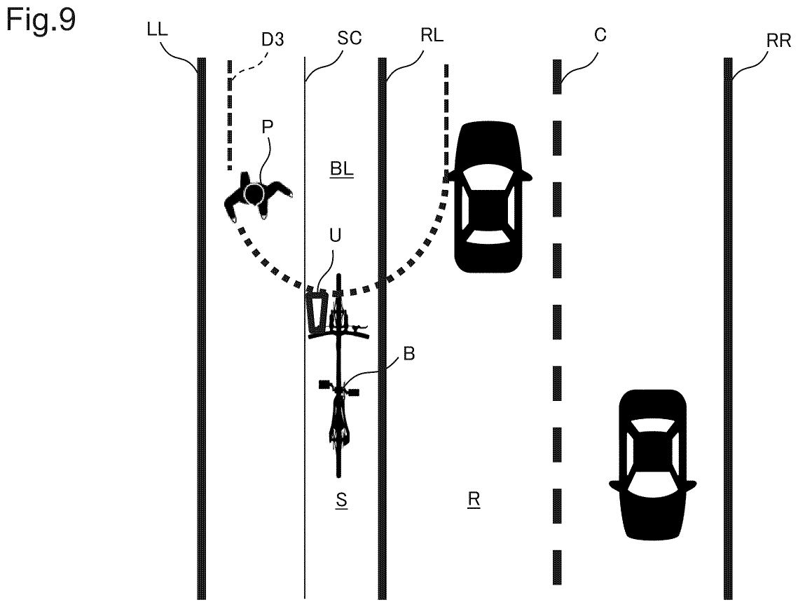

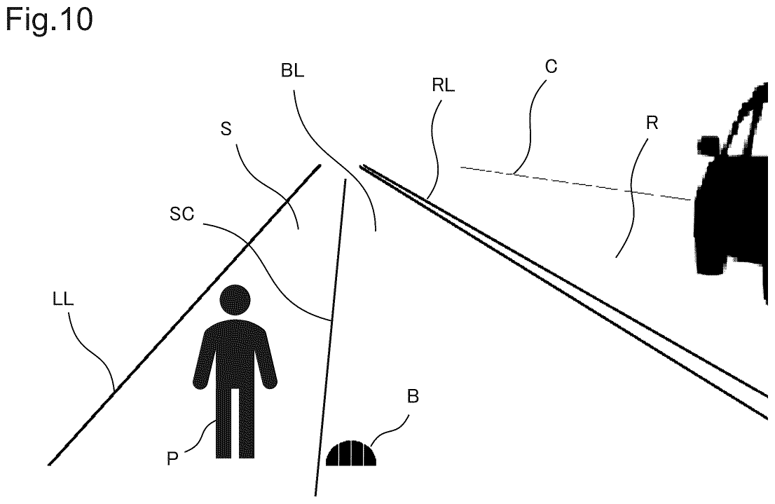

FIGS. 4, 7, and 9 illustrate the first to third traveling situations of the two-wheeled vehicle. FIG. 4 illustrates a traveling situation of traveling on the roadway R, FIG. 7 illustrates a traveling situation of entering the sidewalk S from the roadway R, and FIG. 9 illustrates a situation of traveling on the sidewalk S. In this case, the traveling videos (FIGS. 5, 8, and 10) indicating the first to third traveling situations of the two-wheeled vehicle are acquired by a camera U mounted on the two-wheeled vehicle B. In the drawings, reference numerals D1, D2, and D3 schematically indicate regions imaged by the camera U mounted on the two-wheeled vehicle B.

Each travel information in the drawing transmitted to the driving assistance device 100 in step S002 of FIG. 6 is converted into traveling video data by the video acquisition unit 104. The dangerous driving detection unit 102 acquires the positional relationship between the two-wheeled vehicle B and the sidewalk S from the traveling video data, and detects the dangerous driving in a case where the predetermined distance is exceeded in the direction of the center line C from the edge RL between the sidewalk S and the roadway R (step S003 in FIG. 6). In the present example embodiment, in a case where a bicycle dedicated lane BL (area between the left edge RL of the roadway R and the white line SC on the sidewalk S) on which a bicycle B can travel is installed, and the two-wheeled vehicle B is a bicycle and is traveling outside the bicycle dedicated lane BL, it is detected as dangerous driving.

In a case where it is detected that the bicycle is driving dangerously, dangerous driving is presented (step S004 in FIG. 6). More specifically, regarding the dangerous driving, a warning means connected to the driving assistance device 100 in a wired or wireless manner and including a display unit such as a display mounted on the two-wheeled vehicle B and an audio unit such as a speaker is used to warn the driver of the dangerous driving, and the driver or the manager can know the occurrence of the dangerous driving via a terminal connected to the driving assistance device 100 in a wired or wireless manner. Furthermore, by storing information including an occurrence position and an occurrence time of dangerous driving, a type of dangerous driving, and the like in the storage unit 105 serving as a storage means, it is possible for the driver to browse the information on the dangerous driving before actually traveling, or for the driver to review the content of the dangerous driving afterwards and improve the traveling technique. When the driver approaches the stored occurrence position of dangerous driving, the warning means may be used to warn the driver.

In the traveling situation illustrated in FIG. 7, the two-wheeled vehicle B enters the sidewalk S from the roadway R. At this time, it is necessary to identify whether the two-wheeled vehicle is allowed to travel on the sidewalk S by a two-wheeled vehicle dedicated lane (dedicated lane BL) or the like. In this case, when the traffic sign (for example, “bicycle only” is written in white on the road surface) of the dedicated lane BL is recognized from the traveling video captured by the camera U, it is not identified as dangerous driving by the dangerous driving detection unit 102. The determination as to whether the dedicated lane BL is provided on the sidewalk S may be made based on traffic information stored in advance in the map information DB 101, rather than based on a traveling video by a camera.

Further, in the traveling situation illustrated in FIG. 9, since the two-wheeled vehicle B is traveling on the sidewalk S, when the dangerous driving detection (step S003 in FIG. 6) is executed, it is determined whether the traveling position of the two-wheeled vehicle on the sidewalk S is in the dedicated lane BL. For example, in a case where the traveling position exceeds a predetermined distance from the edge RL of the dedicated lane BL in the leftward direction, information indicating dangerous driving is stored in the map information DB 101 in advance, whereby a configuration for identifying the presence or absence of dangerous driving can be achieved.

In addition to the coordinate information of the sidewalk S, the map information DB 101 may store a width of the sidewalk S (a distance between the white line SC and a sidewalk edge LL), data indicating whether the sidewalk S and the roadway R are roads that are distinguished from each other, and the like. By using the map information, it is possible to widely set a criterion as to whether the driving is relevant to dangerous driving. For example, in a case where the vehicle B is traveling on a sidewalk S having a width larger than a predetermined width or on a sidewalk S adjacent to a roadway R set in advance as a road on which the sidewalk S and the roadway R are distinguished from each other, it is also possible to detect dangerous driving.

As described above, according to the present example embodiment, it is possible to detect whether the traveling situation of the two-wheeled vehicle is relevant to dangerous driving and present the dangerous driving to the driver, so that it is possible to prevent the driver from causing a traffic accident. Furthermore, if the video of the dangerous driving is recorded in the storage unit 105, the driver and the manager can browse the video of the dangerous driving in advance and after the dangerous driving, and even if the driver has little driving experience, the driver can improve the driving skill without receiving the instruction of the driving instructor. Since the manager can also browse the information pertaining to the dangerous driving performed by the driver, the manager can accurately teach the driving method if the manager instructs the driver.

### Second Example Embodiment

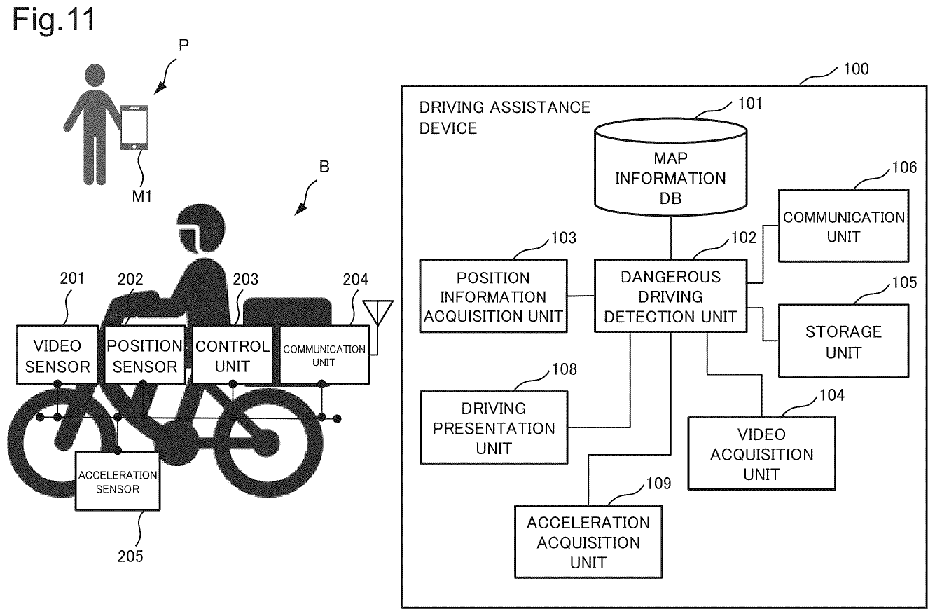

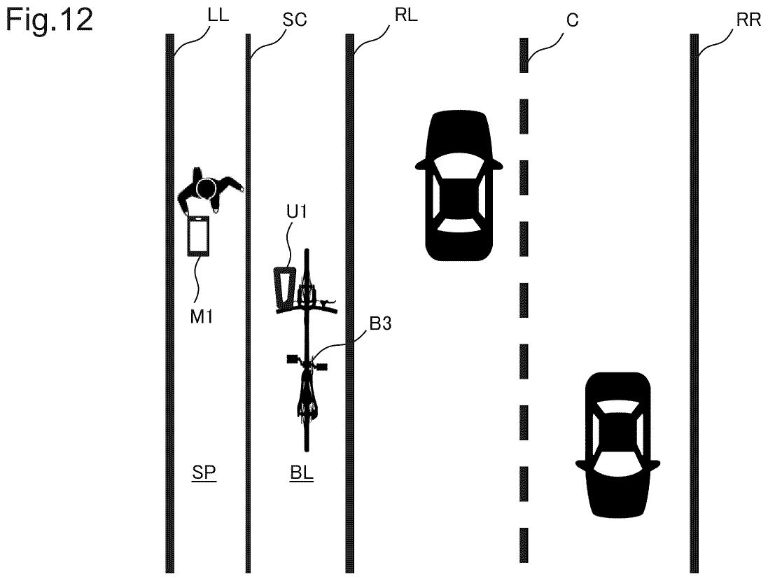

As illustrated in FIG. 11, the second example embodiment has a configuration in which an acceleration sensor 205 is added to the two-wheeled vehicle B of the first example embodiment, and a mobile terminal M1 carried by a pedestrian can be used. By adopting this configuration, it is possible to achieve a configuration in which it is determined that dangerous driving is performed while the bicycle B is traveling on the dedicated lane BL (see FIG. 12) in a case where the bicycle B suddenly brakes in a state where the bicycle B is closer than a predetermined distance to a pedestrian P on the sidewalk S.

The distance between the bicycle B and the pedestrian P can be calculated based on the traveling image from the camera U, or can be acquired by the position information of the bicycle acquired by the position information acquisition unit 103 of the bicycle B and the position sensor such as a GPS mounted on the mobile terminal M1 held by the pedestrian P. The emergency braking of the bicycle B can be identified by identifying whether a predetermined acceleration is exceeded using a known acceleration sensor. The driving assistance device 100 includes an acceleration acquisition unit 109, and the acceleration acquisition unit 109 can calculate the acceleration based on the acceleration information acquired by the acceleration sensor 205 of the bicycle B.

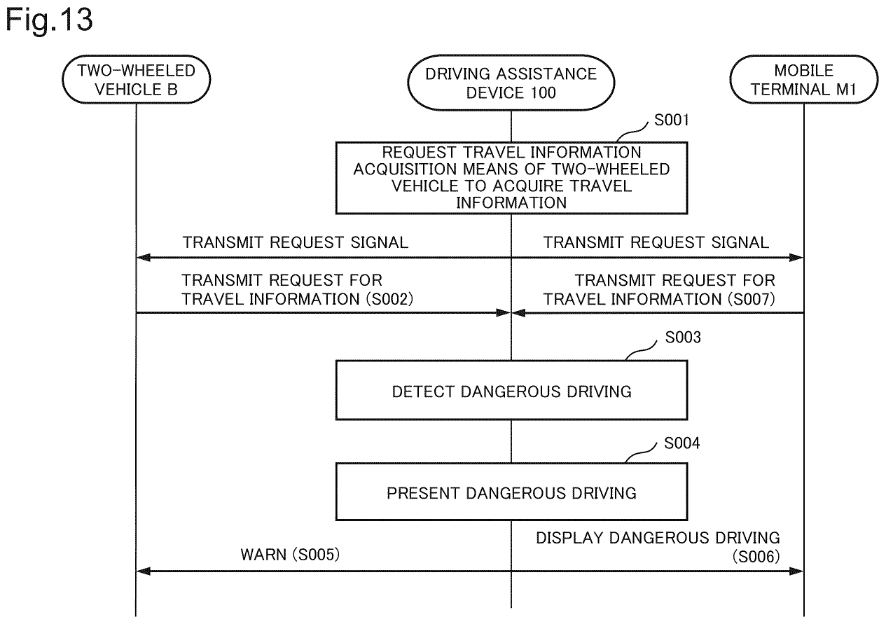

In the second example embodiment having the above configuration, dangerous driving processing is executed as illustrated in FIG. 13. The dangerous driving processing of the second example embodiment has processing steps common to those of the first example embodiment, and thus different processing steps will be mainly described, and processing steps that are not specifically described are the same as those of the first example embodiment.

As illustrated in FIG. 13, a signal requesting acquisition of travel information is transmitted from the driving assistance device 100 to the video sensor 201 and the position sensor 202, which are the travel information acquisition means of the two-wheeled vehicle B, and the position sensor of the mobile terminal M1 (step S001). The two-wheeled vehicle B that has received the request signal transmits travel information to the driving assistance device 100. The acceleration information acquired by the acceleration sensor 205 is acquired by the acceleration acquisition unit 109 of the driving assistance device 100, and the acceleration is calculated (step S002). The position information of the pedestrian P is transmitted from the mobile terminal M1 to the position information acquisition unit 103 of the driving assistance device 100 (step S007), and an interval between the pedestrian P and the two-wheeled vehicle B, that is, distance data between the pedestrian P and the two-wheeled vehicle B is calculated. It goes without saying that the mobile terminal M1 includes a communication means for exchanging commands, information, and the like with the driving assistance device 100.

The acceleration data can be generated by the video acquisition unit 104 based on the traveling video acquired by the video sensor 201 instead of the acceleration sensor 205. Therefore, in a case where the video sensor 201 is used to identify the emergency braking, the acceleration sensor 205 may not be included in the travel information acquisition means of the two-wheeled vehicle B.

In a case where the distance data between the pedestrian P and the two-wheeled vehicle B and the acceleration data of the two-wheeled vehicle B exceed the threshold, the dangerous driving detection unit 102 detects that the two-wheeled vehicle B is performing dangerous driving (step S003 in FIG. 13).

In the above example embodiment, the risk level is identified in a case where both the distance data between the pedestrian P and the two-wheeled vehicle B and the acceleration data of the two-wheeled vehicle B exceed the threshold. However, the risk level may be identified in a case where at least one of the distance data between the pedestrian P and the two-wheeled vehicle B and the acceleration data of the two-wheeled vehicle B exceeds the threshold.

Furthermore, the above-described example embodiment acquires the travel information using the video sensor 201, the position sensor 202, and the acceleration sensor 205 provided in the two-wheeled vehicle B. However, it is also possible to employ a configuration in which a video sensor, a position sensor, and an acceleration sensor included in a mobile terminal of a driver riding on the two-wheeled vehicle B are used to acquire travel information, and distance information between the pedestrian P and the two-wheeled vehicle B and acceleration information of the two-wheeled vehicle B are acquired. In the present example embodiment, since dangerous traveling is identified in consideration of the positional relationship between the vehicle B and the pedestrian P, occurrence of large damage in a traffic accident can be suppressed.

Although the example embodiments of the present disclosure have been described above, the present disclosure is not limited to the above-described example embodiments, and further modifications, substitutions, and adjustments can be made without departing from the basic technical idea of the present disclosure. For example, the network configuration, the configuration of each element, and the expression form of data illustrated in the drawings are examples for assisting the understanding of the present disclosure, and are not limited to the configurations illustrated in the drawings.

For example, in the first example embodiment described above, an example has been described in which a two-wheeled vehicle travels in a passage where a sidewalk is located on substantially the same plane as a roadway. However, the application range of the driving assistance device of the present disclosure is not limited to a vehicle traveling in the passage. For example, the driving assistance device of the present disclosure can also be applied to a vehicle traveling in a passage having different heights of a sidewalk and a roadway or a passage dedicated to a two-wheeled vehicle.

### Hardware Configuration

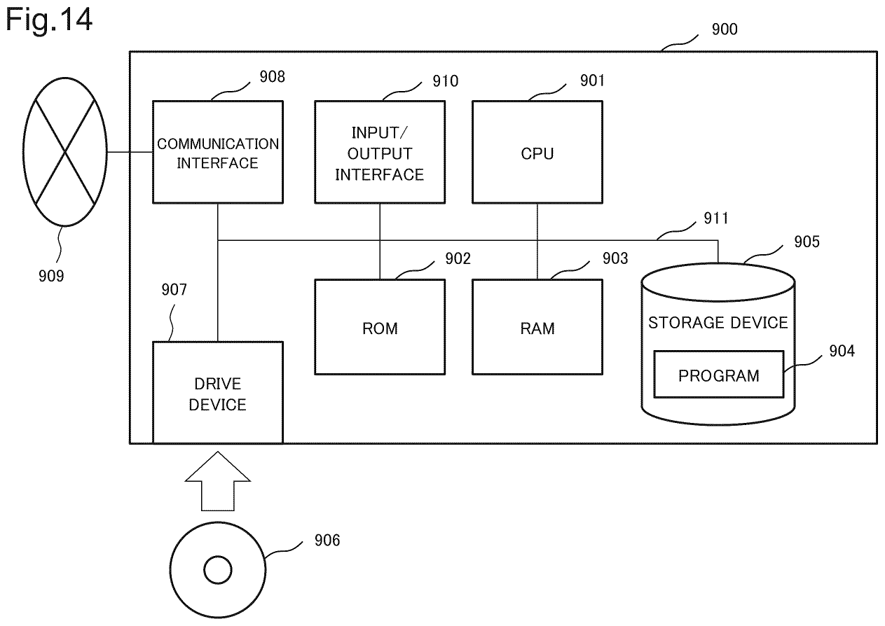

In each example embodiment of the present disclosure, each component of each device indicates a block in units of function. A part or all of each component of each device is achieved by, for example, an arbitrary combination of an information processing device 900 and a program as illustrated in FIG. 14. FIG. 14 is a block diagram illustrating an example of a hardware configuration of the information processing device 900 that achieves each component of each device. As an example, the information processing device 900 includes the following configurations.
CPU (Central Processing Unit) 901
ROM (Read Only Memory) 902
RAM (Random Access Memory) 903
Program 904 loaded into RAM 903
Storage device 905 storing program 904
Drive device 907 that reads and writes recording medium 906
Communication interface 908 connected with communication network 909
Input/output interface 910 for inputting/outputting data
Bus 911 connecting each component

Each component of each device in each example embodiment is achieved by the CPU 901 acquiring and executing a program 904 for achieving these functions. That is, the CPU 901 of FIG. 11 may execute a travel information acquisition program, a dangerous driving detection program, and a dangerous driving presentation program to perform update processing of each calculation parameter held in the RAM 903, the storage device 905, or the like. The program 904 for achieving the function of each component of each device is stored in the storage device 905 or the ROM 902 in advance, for example, and is read by the CPU 901 as necessary. The program 904 may be supplied to the CPU 901 via the communication network 909, or may be stored in advance in the recording medium 906, and the drive device 907 may read the program and supply the program to the CPU 901.

There are various modifications of the method of achieving each device. For example, each device may be achieved by any combination of the information processing device 900 and the program separate for each component. A plurality of components included in each device may be achieved by any combination of one information processing device 900 and a program. That is, each unit (processing means and function) of the driving assistance devices according to the first and second example embodiments can be achieved by a computer program that causes a processor mounted on the devices to execute each processing described above using its hardware.

Some or all of the constituent elements of each device are achieved by other general-purpose or dedicated circuits, processors and the like, or a combination thereof. These may be configured by a single chip or may be configured by a plurality of chips connected via a bus. Some or all of the components of each device may be achieved by a combination of the above-described circuit and the like and a program.

In a case where some or all of the components of each device are achieved by a plurality of information processing devices, circuits, and the like, the plurality of information processing devices, circuits, and the like may be arranged in a centralized manner or in a distributed manner. For example, the information processing device, the circuit, and the like may be achieved as a form in which each is connected via a communication network, such as a client and server system or a cloud computing system.

Each of the above-described example embodiments is a preferred example embodiment of the present disclosure, and the scope of the present disclosure is not limited only to each of the above-described example embodiments. That is, it is possible for those skilled in the art to make modifications and substitutions of the above-described example embodiments without departing from the gist of the present disclosure, and to construct a mode in which various modifications are made.

Some or all of the above example embodiments may be described as the following Supplementary Notes, but are not limited to the following.

### Supplementary Note 1

A driving assistance device including: a travel information acquisition means for acquiring travel information about a vehicle; a detection means for detecting dangerous driving of the vehicle based on sidewalk information that pertains to a sidewalk and that is included in the travel information; and a driving presentation means for presenting the dangerous driving in a case where the dangerous driving has been detected by the detection means.

### Supplementary Note 2

It is possible to adopt a configuration in which

the travel information acquisition means includes a position information acquisition unit that acquires position information of the vehicle, and

the detection means detects the dangerous driving based on the position information and coordinate information of the sidewalk information.

### Supplementary Note 3

It is possible for the detection means to detect the dangerous driving based on position information of a pedestrian.

### Supplementary Note 4

The position information of the pedestrian is acquired by a mobile terminal.

### Supplementary Note 5

The detection means can detect the dangerous driving based on whether a roadway and the sidewalk are distinguished from each other.

### Supplementary Note 6

The dangerous driving may include a case where the detection means detects that a distance between the vehicle and the pedestrian exceeds a threshold and the vehicle suddenly brakes.

### Supplementary Note 7

It is possible to adopt a configuration in which

the travel information acquisition means includes a video acquisition unit that captures a traveling video of the vehicle, and

the detection means compares the traveling video with the sidewalk information and detects the dangerous driving.

### Supplementary Note 8

It is possible to adopt a configuration including a warning means for warning a driver of the vehicle of the dangerous driving.

### Supplementary Note 9

It is possible to adopt a configuration including a storage means for storing an occurrence position of the dangerous driving, in which the storage means stores the occurrence position in association with a place where the dangerous driving has occurred, and the warning means warns the driver near the stored occurrence position.

### Supplementary Note 10

A driving assistance method including:

acquiring travel information of a vehicle;

detecting dangerous driving of the vehicle based on sidewalk information that pertains to a sidewalk included in the travel information; and

presenting the dangerous driving in a case where the dangerous driving has been detected.

### Supplementary Note 11

A recording medium having stored therein a program causing a computer to execute:

acquiring travel information of a vehicle from the vehicle;

detecting dangerous driving of the vehicle based on sidewalk information that pertains to a sidewalk included in the travel information; and

presenting the dangerous driving to a predetermined output destination in a case where the dangerous driving has been detected. The forms of the Supplementary Notes 10 and 11 can be expanded to the forms of the Supplementary Notes 2 to 9, similarly to the Supplementary Note 1.

It is to be noted that the disclosure of the above patent literature is incorporated herein by reference, and can be used as a basis or part of the present disclosure as necessary. Within the frame of the present disclosure (including claims), it is possible to change and adjust the example embodiments or examples further based on the basic technical idea. Various combinations or selections (including partial deletions) of various disclosure elements (each element of each claim, each element of each example embodiment or example, each element of each drawing, and the like are included) can be made within the frame of the present disclosure. That is, it is a matter of course that the present disclosure includes various modifications and corrections that can be made by those of ordinary skill in the art in accordance with the entire disclosure including the claims and the technical idea. In particular, for numerical ranges set forth herein, any numerical value or sub-range included within the range should be construed as being specifically described, even if not stated otherwise. Furthermore, it is also deemed that the disclosure of the present application includes use of some or all of the disclosed matters of the cited documents as part of the present disclosure in combination with the described matters of the present disclosure in accordance with the gist of the present disclosure as necessary.

### REFERENCE SIGNS LIST

11 travel information acquisition means
12 dangerous driving detection means
13 driving presentation means
100 driving assistance device
101 map information database (map information DB)
102 dangerous driving detection unit
103 position information acquisition unit
104 video acquisition unit
105 storage unit
106 communication unit
108 driving presentation unit
109 acceleration acquisition unit
201 video sensor
202 position sensor
203 control unit
204 communication unit
205 acceleration sensor
900 information processing device
901 CPU (Central Processing Unit)
902 ROM (Read Only Memory)
903 RAM (Random Access Memory)
904 program
905 storage device
906 recording medium
907 drive device
908 communication interface
909 communication network
910 input/output interface
911 bus
BL bicycle dedicated lane
LL sidewalk edge
M1 mobile terminal
P pedestrian
R roadway
RL, RR roadway edge
S sidewalk
SC white line
U camera

What is claimed is:

1. A driving assistance device comprising:
at least one memory configured to store instructions; and
at least one processor configured to execute the instructions to:
acquire travel information about a vehicle;
detect dangerous driving of the vehicle based on sidewalk information related pertains to a sidewalk, the sidewalk information included in the travel information; and
present the dangerous driving.

2. The driving assistance device according to claim 1,
wherein the at least one processor is further configured to execute the instructions to:
acquire position information of the vehicle, and
detect the dangerous driving based on the position information and coordinate information of the sidewalk.

3. The driving assistance device according to claim 1,
wherein the at least one processor is further configured to execute the instructions to:
detect the dangerous driving based on position information of a pedestrian.

4. The driving assistance device according to claim 3, wherein
the position information of the pedestrian is acquired by a mobile terminal.

5. The driving assistance device according to claim 2,
wherein the at least one processor is further configured to execute the instructions to:
detect the dangerous driving based on whether a roadway and the sidewalk are distinguished from each other.

6. The driving assistance device according to claim 3, wherein the at least one processor is further configured to execute the instructions to:
detect the dangerous driving in a case where a distance between the vehicle and the pedestrian exceeds a threshold and the vehicle suddenly brakes.

7. The driving assistance device according to claim 1,
wherein the at least one processor is further configured to execute the instructions to:
capture a traveling video of the vehicle, and
compare the traveling video with the sidewalk information and detects the dangerous driving.

8. The driving assistance device according to claim 1,
wherein the at least one processor is further configured to execute the instructions to:
warn a driver of the vehicle of the dangerous driving.

9. The driving assistance device according to claim 8,
wherein the at least one processor is further configured to execute the instructions to:
warn the driver near an occurrence position stored in a storage device.

10. A driving assistance method comprising:
acquiring travel information of a vehicle;
detecting dangerous driving of the vehicle based on sidewalk information that pertains to a sidewalk included in the travel information; and
presenting the dangerous driving in a case where the dangerous driving has been detected.

11. A non-transitory recording medium having stored therein a program causing a computer to execute:
acquiring travel information of a vehicle from the vehicle;
detecting dangerous driving of the vehicle based on sidewalk information that pertains to a sidewalk included in the travel information; and
presenting the dangerous driving to a predetermined output destination in a case where the dangerous driving has been detected.
